(19) United States
(12) Patent Application Publication
(10) Pub. No.: US 2013/0068677 A1
(43) Pub. Date: Mar. 21, 2013

(54) FILTER GROUP FOR INTERNAL COMBUSTION ENGINES

(71) Applicant: Giorgio Girondi, Mantova (IT)

(72) Inventor: Giorgio Girondi, Mantova (IT)

(73) Assignee: UFI INNOVATION CENTER S.R.L., Ala (Trento) (IT)

(21) Appl. No.: 13/699,714

(22) PCT Filed: Apr. 12, 2011
(86) PCT No.: PCT/IB2011/000820

§ 371 Date: Nov. 24, 2012

(30) Foreign Application Priority Data
May 25, 2010 (IT) RE2010A000041

(51) Int. Cl. B01D 27/14; B01D 27/10

(52) U.S. Cl. CPC B01D 27/144; B01D 27/14; B01D 27/103
USPC 210/130; 210/295; 210/314

(57) ABSTRACT

A filter cartridge for fuel, includes a first filter element and a second filter element, which is of a flat type and is located downstream of the first filter element with reference to a direction of the fuel, the filter elements are configured such as to be crossed in series by the fuel, in which the first filter element is a depth filter and has a mean porosity value which is greater than the porosity of the second filter element and which is such as to retain large-dimension paraffins and a part of smaller-dimension particulates, while enabling passage of small-dimension paraffins.

### TECHNICAL FIELD

The invention relates to a fuel filter group destined to be associated to internal combustion engines.

### BACKGROUND ART

As is known, the filtration of a fluid is done by passing the fluid to be filtered through a filter element which is able to retain the impurities present in the transiting fluid.

The filtering elements generally sub-divide into two main categories: flat filter elements and depth filter elements.

Flat filter elements are realised in such a way that the impurities present in the fluid are retained and accumulate practically only at the interface surface of the filter element which is first struck by the fluid to be filtered; while depth filter elements are realised such that the impurities are retained and accumulate in the whole thickness of the filter element.

For this reason, flat filter element needs an interface surface with the fluid to be filtered which is as large as possible, but can have a comparably very slim thickness. For example, to increase the interface surface, a known method gives the flat filter elements a pleated conformation, with the pleats possibly closed on each other such as to obtain a star geometry; or the flat filter elements are tape-formed, first folded longitudinally to form a pouch and then spiral-wound, such as to obtain a cylindrical body that is commonly known as a roll.

Differently, depth filter elements must have a rather large thickness with an interface surface which can be maintained comparatively small. In particular, depth filter elements are typically made cylindrical in shape, with smooth lateral surfaces and a considerably greater thickness with respect to flat filter elements.

Depth filter elements are normally made of a non-woven textile of polymer fibres, for example by means of a melt-blown process. Flat filter elements are often made of cellulose fibres, but can also be made of non-woven textile by means of a melt-blown process.

In the field of fuel filtration, in particular diesel fuel, the use of a filter cartridge is known, which comprises two filter elements, commonly also known as filter membranes, configured such as to be crossed in series by the fuel to be filtered. The membranes have both the function of pre-filter and filter and the function of coalescent elements and/or hydrophobic barriers against the drops of water that are present in the diesel fuel.

Prior patent EP0593434 describes a diesel filter comprising a filter cartridge of the above-described type, made up of an upstream membrane and by a downstream membrane positioned below the upstream membrane, and coaxially thereof. The upstream membrane functions both as a pre-filter, i.e. a separator of the particles of solid pollutants, and as a coalescent element of the drops of water present in the diesel. The downstream membrane functions as both a hydrophobic barrier and as a filter for the small-dimension particles not retained by the upstream filter.

Both the upstream and the downstream membranes are flat and pleated in a star shape. This configuration enables low load loss and a modest amount of clogging due to the large filtering surface.

However, because of the paraffins which form in the diesel at low temperatures, in order to avoid clogging of the upstream membrane, it has to have a high porosity and thus exhibits some drawbacks in relation to the excessive accumulation of the solid particulate in the downstream filter, which results in a shorter working life of the filter cartridge.

A similar solution is described in prior patent EP1932574, which discloses a filter for fuel which comprises two pleated tubular membranes that are coaxial and arranged one above another and are destined to be crossed in series by the fuel to be filtered. Each of these membranes comprises two superposed layers of non-woven textile, of which an external layer made of polymer fibres using the melt-blown method and an internal layer made of cellulose. The upstream filter membrane has a greater porosity with respect to the downstream membrane. A coalescing layer of cellulose is provided between the two membranes such as to facilitate separation of the water. Both the filter membranes are flat, as is demonstrated by the slimness and the pleated conformation which increases the interface surface.

Patent EP0709553 describes another filter model which comprises two tubular superposed filter membranes, destined to be crossed in series by the fluid to be filtered, in the example lubricating oil. In this case too both the filter membranes used are flat and pleated.

Patent EP154452 describes a fuel filter, which comprises two filter membranes destined to be crossed in series, which are tubular, coaxial and superposed, of which an upstream membrane and a downstream membrane. The upstream membrane is a flat filter membrane made in a “rolled” conformation. The downstream filter membrane is realised with a layer of is polymer fibres obtained using the melt-blown method, and is slim and star-shaped, and thus configures a second flat filter membrane.

Patent DE102007048550 discloses a filter also having two membranes destined to be crossed in series by the fluid. The upstream membrane is a true and proper filter element, while the downstream membrane is a coalescent membrane for water separation. Both membranes are flat and pleated.

All of these solutions exhibit the same problem: i.e. in order to prevent blockage of the upstream membrane, the said upstream membrane has to have high porosity and thus exhibits defects relating to the excessive accumulation of the solid particulate in the downstream membrane, which translates into a shorter working life of the filter cartridge.

### DISCLOSURE OF INVENTION

The aim of the present invention is to obviate the problems of the prior art with a solution which is rational and relatively inexpensive.

The aim is attained by a filter cartridge as set out in claim 1.

In the invention, the upstream filter element is a depth filter, i.e. constituted by a mass of a porous fibrous material which is crossed by the liquid to be filtered.

Differently to flat filter elements, depth filter elements generally have a variable porosity in the sense of the thickness thereof.

In depth filter elements the value of the porosity therefore has a mean value, and they exhibit the characteristic of retaining particles whose dimensions are not strictly linked to the mean value of porosity.

Thus it is true to say that a filter element having a mean porosity of a certain value statistically also retains a part of very much smaller particles.

This is why depth filter elements are never attributed the function of prefilters, as they provide, substantially, a high efficiency with a mean porosity.

In the invention, a fuel filter cartridge is provided comprising a first filter element and a second filter element of the flat type, typically pleated, located downstream of the first filter element with reference to the direction of the fuel, the filter membranes being configured such as to be crossed in series by the fuel.

In particular, the first filter element is a depth filter and has a porosity value which is greater than the porosity value of the second filter element and which is such as to retain, with no clogging, not only coagulated paraffins of larger dimensions, but also a majority of the particulate having much smaller-sized particles.

The first depth filter element preferably has a minimum porosity, i.e. the porosity of the more dense layer, which is greater than the porosity of the flat second filter element.

In this way, it enables passage of a part of the paraffins having smaller dimensions, while at the same time purifying the fluid of a part of the particulate having smaller dimensions than the paraffins.

The depth filter element therefore allows passage of the coagulated paraffins in the larger sizes, together with a part of the particulate which is even smaller than the mean porosity.

In the invention, the porosity of the depth filter element is comprised between 5 and 100 μm, and preferably comprised between 10 and 40 μm.

In the invention, the porosity values of the flat pleated filter element are comprised between 0.5 and 10 μm, and preferably comprised between 1 and 5 μm.

The cartridge of the invention, which includes a first filter element of the depth filter type, having a high mean porosity and a second filter element, located downstream of the first filter, which is a flat pleated or star-shaped filter having a comparatively lower porosity, has the advantage of exhibiting low load losses.

The depth filter element has a porosity value which is such as to enable a high accumulation of the solid particulate while at the same time retaining only a part of the paraffins which form at low diesel fuel temperatures.

In this way, the clogging of the flat pleated filter element is prevented; this is filter element is dedicated only to the filtration of particles of particulate which are smaller than the porosity value of the depth filter element.

A further advantage of this embodiment of the invention is that it enables a high degree of separation of the water, as the depth filter element can be of such dimensions as to perform a coalescent action; the separation can be completed with use of a hydrophobic mesh located upstream of the pleated filter element and downstream of the depth filter element.

In a preferred embodiment of the invention, the first and the second filter membranes both have a tubular shape, or toroidal, and are coaxially superposed on one another, such as to realise a quite compact filter cartridge.

Further, the second filter element (pleated) preferably has a truncoconical shape which narrows in an opposite direction to the first filter element.

The truncoconical shape facilitates the downwards-directed outflow of the drops of water which separate by coalescence at the first filter membrane.

In an embodiment of the invention a fuel filter group is provided which comprises an external cartridge configured to receive a filter cartridge made according to the first embodiment of the invention, the cartridge dividing the internal volume of the casing into three distinct chambers, of which a first and a third chamber are located respectively in communication with an inlet conduit and an outlet conduit of the fuel, and a second chamber located between the two filter elements.

In a particularly advantageous shape of the fuel filter group according to the invention, between the first and the second chambers there is a by-pass valve the opening of which is a function of the pressure value of the fuel in the first chamber.

The further dependent claims delineate preferred and particularly advantageous embodiments of the filter of the invention.

### BRIEF DESCRIPTION OF THE DRAWINGS

Further characteristics and advantages of the invention will emerge from a reading of the following description, which is provided by way of non-limiting example, with the aid of the figures of the accompanying tables of drawings, in which:

FIG. 1 is a section view along an axial vertical plane of a first embodiment of the filter group, according to the present invention;

FIG. 2 is a section view along an axial vertical plane of a second embodiment of the filter group, according to the present invention;

FIG. 3 is a section view along an axial vertical plane of a third embodiment of the filter group, according to the present invention.

### BEST MODE FOR CARRYING OUT THE INVENTION

In the figures of the drawings, reference is made to an embodiment of the invention relating to a filter group 1 for diesel fuel, although other embodiments of the invention can relate to filter groups associated to the filtration of different types of fuel.

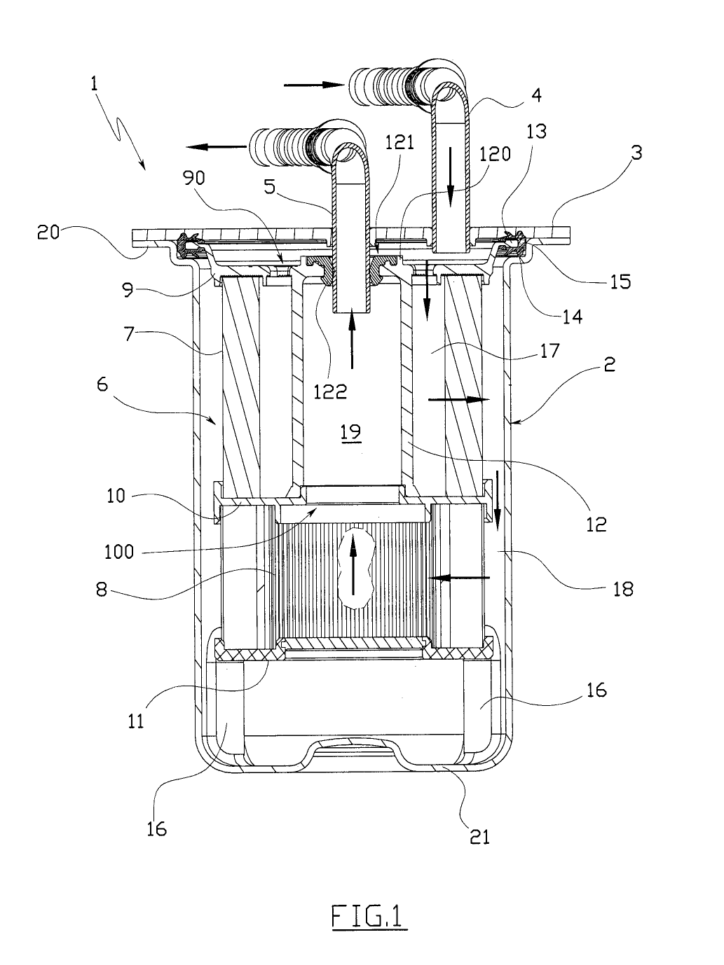

FIG. 1 shows the filter group 1, which comprises an external casing 2, beaker-conformed and superiorly closed by a cover 3 on which an inlet conduit 4 and an outlet conduit 5 of the fuel are located.

A filter unit 6 is located inside the casing 2, which unit 6 comprises two filter elements 7 and 8, which are toroidal, coaxial and superposed. The elements 7 and 8 will be referred-to as filter membranes henceforth in the body of the present description.

In particular, the filter unit 6 comprises an upper plate 9, an intermediate plate 10 and a lower plate 11. The upper plate 9 and the intermediate plate 10 exhibit a respective axial central hole (90, 100) for receiving a hollow conduit 12, known in the sector as a core, which lends structural rigidity to the cartridge 6.

The hollow conduit 12 in turn exhibits an annular edge 120 which defines a hole 121 in which a portion of the inlet conduit 5 is housed, with an interposing of a seal gasket 122.

The first filter membrane 7, a depth filter, is located between the upper plate 9 and the intermediate plate 10, while the second filter membrane 8, which is pleated (or star-shaped) is located between the intermediate plate 10 and the lower plate 11.

The upper plate 9 of the cartridge 6 exhibits an annular edge 13 destined to be received in a conjoined gully 14 afforded at the upper edge 20 of the casing 2, with the interposing of a seal gasket 15. Below, the cartridge 6 is rested on three tabs 16, two of which are visible in FIG. 1, angularly equidistanced from one another and deriving from a bottom membrane 21 of the casing 2.

The two filter membranes 7 and 8 of the filter cartridge 6 are configured such as to be crossed in series by the fuel, and separate the internal volume of the casing 2 into three distinct chambers 17, 18 and 19. In particular, the intermediate chamber 18 is located between the two filter membranes 7 and 8, i.e. downstream of the first filter membrane 7 and upstream of the second filter membrane 8, while the chamber 17, or the first chamber, is placed in communication with the inlet conduit 4 of the fuel, and the chamber 19, or the third chamber, is set in communication with the outlet conduit 5 of the fuel.

The filter membrane 7 is a depth filter and exhibits a porosity which is such as to retain the particulate but to let pass at least a part of the paraffins which form at low temperatures. Thanks to this characteristic, the filter membrane 7 performs a pre-filtering function, exhibiting a high retaining action on the particulate but at the same time enabling the engine on which the filter is installed to be started up even at low temperatures. The porosity value of the filter membrane 7 is such as also to perform a coalescence action on the drops of water which separate from the diesel such as to be collected at the bottom 21 of the casing 2, which functions as a collection tray.

In the invention, the porosity of the depth filter membrane 7 is comprised between 5 and 100 μm, and preferably comprised between 10 and 40 μm. The second filter membrane 8, which is pleated or star-shaped, performs the action of filtering the particles of particulate which are smaller and which cross the first filter membrane 7.

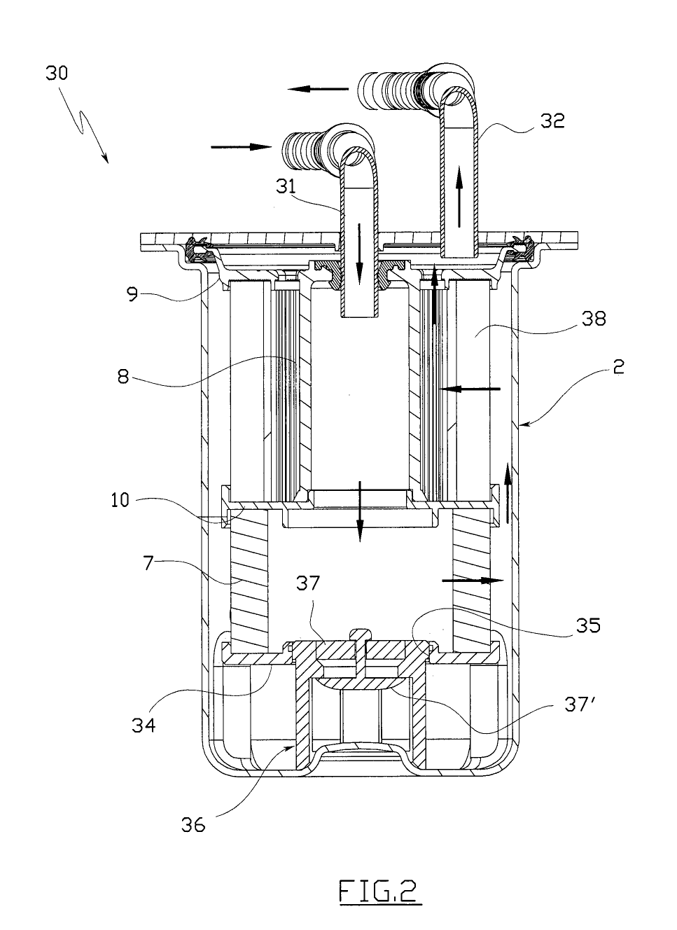

In the invention, the porosity of the filter membrane 8 is comprised between 0.5 and 10 μm, and preferably comprised between 1 and 5 μm. The FIG. 2 illustrates a second embodiment of the filter group of the invention. It is specified that in describing the second embodiment the same numerical indications are used for describing parts which are identical and already described in relation to the first embodiment of the invention.

FIG. 2 shows that the filter group 30, which comprises the external casing 2, is beaker-shaped and superiorly closed by the cover 3 on which an axial fuel inlet conduit 31 and a fuel outlet conduit 32 are located.

A filter unit 33 is located internally of the casing 2, comprising two filter membranes 7 and 8, which are toroidal, coaxial and superposed. This realisation of the invention differs from the previously-described one due to the fact that the filter membrane 8, which is pleated, is located between the upper plate 9 and the intermediate plate 10, and the depth filter membrane 7 is located between the intermediate plate 10 and a lower plate 34. The lower pate 34 exhibits a central hole 35 destined to receive a by-pass valve 36 comprising a valve body 37 and an obturator 37′, which is mushroom-shaped. The by-pass valve has the function of enabling the fuel to by-pass the depth filter membrane 7 when the membrane 7 clogs up due to saturation of particulate or the large-size paraffin particles. Further, in the second embodiment of the invention, there is a hydrophobic mesh 38, made of PTFE (polytetrafluoroethylene) or polymers treated with hydrophobic substances, having a cylindrical shape and located between the upper plate 9 and the intermediate plate 10 externally of the filter membrane 8.

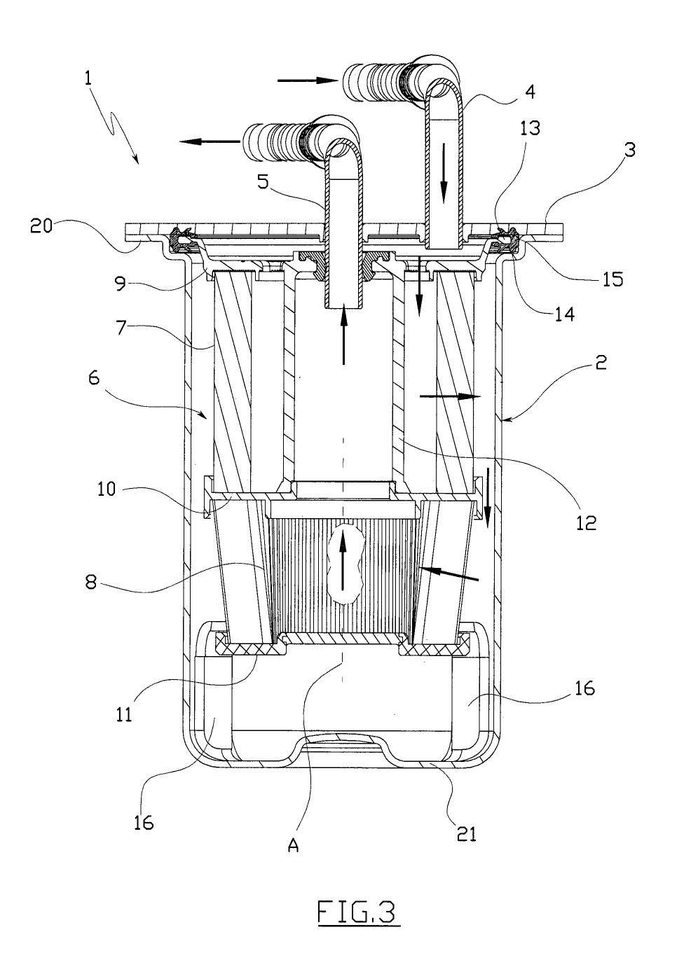

FIG. 3 illustrates a third and preferred embodiment of the filter group 1 of the invention. It is specified that in this case too in describing the third embodiment the same numerical references are used to describe the components which are identical to those described in the first embodiment of the invention.

FIG. 3 illustrates the filter group 1, which comprises the external casing 2, beaker-shaped and superiorly closed by the cover 3 on which the inlet conduit 4 and an outlet conduit for the fuel are located.

The filter unit 6 is housed internally of the casing 2, which filter unit 6 comprises the two filter membranes 7 and 8, which are toroidal, coaxial and superposed, in which the upper membrane 7 is the depth filter membrane destined to perform the prefiltration, and the lower filter membrane 8 is the pleated or star-shaped membrane which performs the filtering action of the smaller particles of particulate that pass through the first filter membrane 7.

The present embodiment of the invention differs from the first described embodiment, in that the downstream pleated filter membrane 8 is truncoconical, with the larger base located adjacent to the depth filter membrane 7, and the smaller base located lower.

In practice, the pleated filter membrane 8 has a truncoconical shape which tapers in a downwards direction, i.e. towards the bottom 21 which functions as a collection tray for the water drops which separate from the diesel at the filter membrane 7, thanks to the above-mentioned coalescence function thereof.

This shape of the filter membrane 8 has the advantage of leaving, internally of the casing 2, a greater passage section for the drops of water in proximity of the collection tray 21, thus facilitating the flow of the drops downwards.

Further, this embodiment is such that the direction of the fuel flow crossing the filter membrane 8 is inclined with respect to the direction (substantially vertical) the drops flow in.

This means that the flow of fuel crossing the filter membrane 8 exerts, on the drops of water, a pressure directed internally of the filter membrane 8 which pressure is lower with respect to the pressure in the embodiment of FIG. 1.

In this way, the risk of a certain quantity of drops of water passing through the filter membrane 8 is advantageously reduced.

In more detail, the lateral membranes of the filter membrane 8 are inclined such as to form, with the central axis A of the filter membrane 8, an angle comprised between 1° and 30°, preferably between 4° and 6°.

In this third embodiment of the invention too, a hydrophobic mesh can be used, made of PTFE (polytetrafluoroethylene) or polymers treated with hydrophobic substances, which externally clads the filter membrane 8.

The hydrophobic mesh will clearly have the same truncoconical shape of the filter membrane 8, with the same inclination of the lateral membranes.

The invention is not limited to the above-described examples, and any variants and improvements can be brought to it without its forsaking the ambit of the following claims.

1. A filter cartridge (6) for fuel, comprising a first filter element (7) and a pleated second filter element (8), which is of a flat type and is located downstream of the first filter element with reference to a direction of the fuel, the filter elements (7, 8) being configured such as to be crossed in series by the fuel, the first filter element (7) is a depth filter and has a mean porosity value which is greater than a porosity of the second filter element (8) and which is such as to retain large-dimension paraffins and a part of smaller-dimension particulates, while enabling passage of small-dimension paraffins.

2. The filter cartridge (6) for fuel of claim 1, wherein values of the mean porosity of the first, depth filter element (7) are comprised between 5 and 100 μm.

3. The filter cartridge (6) for fuel of claim 1, wherein values of the mean porosity of the first, depth filter element (7) are comprised between 10 and 40 μm.

4. The filter cartridge (6) for fuel of claim 1, wherein values of the porosity of the second, flat filter element (8) are comprised between 0.5 and 10 μm.

5. The filter cartridge (6) for fuel of claim 1, wherein values of the porosity of the second, flat filter element (8) are comprised between 1 and 5 μm.

6. The filter cartridge for fuel of claim 1, further comprising a hydrophobic mesh upstream of the second, flat filter element (8).

7. The filter cartridge (6) for fuel of claim 1, wherein the first filter element (7) and the second filter element (8) are both tubular and are coaxially superposed on one another.

8. The filter cartridge (6) for fuel of claim 7, wherein the second filter element (8) has a truncoconical shape which tapers in an opposite direction to the first filter element (7).

9. The filter cartridge (6) for fuel of claim 7, wherein the second filter element (8) is pleated.

10. A fuel filter group comprising an external casing (2) configured such as to house the filter cartridge (6) of claim 1, the cartridge (6) dividing an internal volume of the casing (2) into three distinct chambers, of which a first chamber and a third chamber are respectively placed in communication with an inlet conduit (4) and an outlet conduit (5) of the fuel and a second chamber is placed between the two filter elements.

11. The fuel filter group of claim 10, wherein a by-pass valve (36) is located between the first chamber (7) and the second chamber (8), an opening of which by-pass valve (36) is a function of a pressure value of the fuel in the first chamber (7).
